(19) United States
(12) Patent Application Publication
(10) Pub. No.: US 2022/0009234 A1
(43) Pub. Date: Jan. 13, 2022

(54) PRINTHEAD CLEANING SYSTEMS AND METHODS

(71) Applicant: Georgia-Pacific Corrugated LLC, Atlanta, GA (US)

(72) Inventors: Rachel Joyce KLEIN, Cincinnati, OH (US); Daniel David KIMMERLY, Lebanon, OH (US); Brian James REILLY, Atlanta, GA (US); Michael T. PAYNE, Sandy Springs, GA (US); Timothy C. HOLSCHER, La Mesa, CA (US); Ernest Barfield WIDNER, Flowery Branch, GA (US)

(21) Appl. No.: 17/305,460

(22) Filed: Jul. 8, 2021

Related U.S. Application Data
(60) Provisional application No. 63/051,237, filed on Jul. 13, 2020.
(60) Provisional application No. 63/068,591, filed on Aug. 21, 2020.

(51) Int. Cl. B41J 2/165

(52) U.S. Cl. CPC B41J 2/16552; B41J 15/00; B41J 2002/16558

(57) ABSTRACT

A system for cleaning printheads used for printing on a roll of web product is provided herein. The system includes at least one printhead configured to print ink on the roll of web product to form a roll of printed web product, and a cleaning device comprising a wipe. The system further includes a controller configured to perform a cleaning operation by causing application of a cleaning additive to a portion of the wipe and causing the cleaning device to translate across the printhead to cause the portion of the wipe to be wiped across the printhead to clean the printhead. The wipe is applied with a fluid, such as water, or a non-wetted cleaning product. Multiple passes of the cleaning device can be utilized, such as where the portion of the wipe has different or no cleaning additives. Cleaning assistance, such as vibration or heat, can be utilized.

### RELATED APPLICATIONS

This application claims priority to U.S. Provisional Patent Application Nos. 63/051237, filed on Jul. 13, 2020, and 63/068591, filed on Aug. 21, 2020, which are incorporated herein by reference in their entireties.

### BACKGROUND

Web products are often used in printing systems. Such printing systems and web product may be utilized for paper, sheet, and/or box and other manufacturing systems to form a finished paper-based product, such as printed sheets, folded carton, beverage containers, labels, flexible paper, industrial bags, plates, cups, decor, and many other things. The printing systems print one or more images (e.g., symbols, marketing indicia, product information, etc.) on the web product as it passes through a print section.

It is desirable to provide high throughput for such print jobs while providing high quality printing. Further, it is desirable to accommodate printing on various types of web product (e.g., white top, brown kraft, masterliner, etc.), whether coated or uncoated. However, printheads used for such printing need to be cleaned often and, sometimes, replaced. Further, there can be significant operational downtime associated with cleaning and/or replacing printheads that could otherwise be used to run print jobs.

### SUMMARY

Some embodiments of the present invention provide an improved cleaning operation that utilizes one or more material wipes that are wiped across the printheads. Depending on the desired configuration, one or more cleaning additives can be applied to the wipe for increased cleaning effectiveness. The cleaning additive could be pre-applied (e.g., form a pre-moistened wipe), or could be applied prior to or in conjunction with a wiping operation (such as to the portion of the wipe being wiped across the printhead). Such cleaning additives can be a fluid or a non-wetted cleaning product. In some embodiments, the fluid may be distilled water. Additionally or alternatively, cleaning assistance features may be utilized, such as providing heat, cold, vibration, and/or sound to enhance the cleaning operation. In some embodiments, multiple passes of the wipe across the printhead(s) may be used, which may include passes with different cleaning additives or cleaning assistance features. Further, such optionality may be switched between depending various factors (e.g., print quality of the printhead, recent or future paper types being printed on, recent or future ink types being printed with, age of the printhead, etc.). Such a cleaning operation may be performed automatically and can occur at any suitable point, such as between print job runs.

Using a wetted wipe as opposed to an unwetted wipe, for example, has shown significant results in improving printhead print quality and expanding the lifetime of the printheads—while also reducing the operational downtime associated with performing extra cleaning operations, replacing printheads, and/or having to rerun undesirable print jobs. However, additional types of cleaning additives and cleaning assistance features are also contemplated for improving printhead print quality and expanding the lifetime of the printheads. Accordingly, example embodiments contemplate automatically controlling cleaning operations using cleaning devices with cleaning additives applied and/or utilizing cleaning assistance features.

Example embodiments of the present invention also contemplate providing an automated (or partially-automated) cleaning operation determination process that can be utilized, such as, to determine when to perform a cleaning operation, determine how to perform the cleaning operation, and determine when an alert should be provided to an operator (e.g., indicating that it is time to perform a cleaning operation and/or time to replace one or more printheads).

### BRIEF DESCRIPTION OF THE DRAWING(S)

Having thus described the invention in general terms, reference will now be made to the accompanying drawings, which are not necessarily drawn to scale, and wherein:

FIG. 1 shows a block diagram of a printing system for printing on web product, in accordance with some embodiments discussed herein;

FIG. 2 shows a block diagram of the printing system shown in FIG. 1, wherein example cleaning devices are further illustrated, in accordance with some embodiments discussed herein;

FIG. 3 shows a schematic representation of two rows of printheads used in a printing system, in accordance with some embodiments discussed herein;

FIG. 4 shows a schematic representation of an example printhead cleaning system that uses cleaning devices performing a cleaning operation by wiping across the printheads in the two rows of printheads, in accordance with some embodiments discussed herein;

FIG. 5 shows a schematic representation of another example printhead cleaning system that provides fluid from fluid application devices to the cleaning devices used to perform a cleaning operation on the printheads in the two rows of printheads, in accordance with some embodiments discussed herein;

FIG. 6 shows a perspective right side view of an example cleaning device, in accordance with some embodiments discussed herein;

FIG. 7 shows a perspective left side view of the example cleaning device shown in FIG. 6, in accordance with some embodiments discussed herein;

FIG. 8A shows a schematic representation of an example cleaning additive application device spraying cleaning additive onto a portion of a wipe of an example cleaning device, in accordance with some embodiments discussed herein;

FIG. 8B shows a schematic representation of another example cleaning additive application device applying cleaning additive to a portion of a wipe of an example cleaning device via a roller, in accordance with some embodiments discussed herein;

FIG. 8C shows a schematic representation of another example cleaning device that includes pre-moistened wipes, wherein an enclosure is used for the cleaning device, in accordance with some embodiments discussed herein;

FIG. 9 shows a schematic representation of another example printhead cleaning system that utilizes a set of cleaning devices, with one cleaning device on each end of the row of printheads, to perform a cleaning operation, in accordance with some embodiments discussed herein;

FIG. 10 shows a schematic representation of another example printhead cleaning system that utilizes a set of cleaning devices, with one cleaning device on each end of the row of printheads, to perform a cleaning operation, where one of the cleaning devices for a set is configured to be non-wetted, in accordance with some embodiments discussed herein;

FIG. 11 shows a schematic representation of another example printhead cleaning system that provides one or more cleaning additives from one or more cleaning additive application devices to the cleaning devices used to perform a cleaning operation, in accordance with some embodiments discussed herein;

FIG. 12 shows a schematic representation of another example printhead cleaning system that provides one or more cleaning additives and/or one or more cleaning assistance features to the cleaning devices used to perform a cleaning operation, in accordance with some embodiments discussed herein;

FIG. 13 shows an example printing system and corresponding web path for the web product passing by rows of printheads for printing thereon, in accordance with some embodiments discussed herein;

FIG. 14 shows a portion of the printing system with a door opened to enable maintenance on the printheads and cleaning devices, in accordance with some embodiments discussed herein;

FIG. 15 illustrates a before and after rendering of print quality of a row of printheads, where the bottom half shows the print quality after being cleaned with a dry wipe with no cleaning additives, and where the top half shows the print quality after being cleaned with example cleaning devices that included a wetted wipe, in accordance with some embodiments discussed herein;

FIG. 16 illustrates a before and after rendering of print quality on printed web product, where the left image shows the print quality after being cleaned with a dry wipe with no cleaning additives, and where the right image shows the print quality after being cleaned with example cleaning devices that included a wetted wipe, in accordance with some embodiments discussed herein;

FIG. 17 illustrates a before and after image of printhead quality scores, where the left image shows the print quality scores after being cleaned with a wipe with no cleaning additives, and where the right image shows the print quality scores after being cleaned with example cleaning devices that included a wetted wipe, in accordance with some embodiments discussed herein;

FIG. 18 shows a schematic representation of an example printhead cleaning system for monitoring printhead performance and performing cleaning operations, in accordance with some embodiments discussed herein;

FIG. 19 illustrates a flowchart of an example method for printing on web product and cleaning printheads, in accordance with some embodiments discussed herein;

FIG. 20 illustrates a flowchart of another example method for printing on web product and cleaning printheads, in accordance with some embodiments discussed herein;

FIG. 21 illustrates a flowchart of another example method for printing on web product and cleaning printheads, in accordance with some embodiments discussed herein; and

FIG. 22 illustrates a flowchart of an example method for monitoring printhead print quality, performing cleaning operations, and/or providing notifications, in accordance with some embodiments discussed herein.

### DETAILED DESCRIPTION OF THE PREFERRED EMBODIMENTS

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

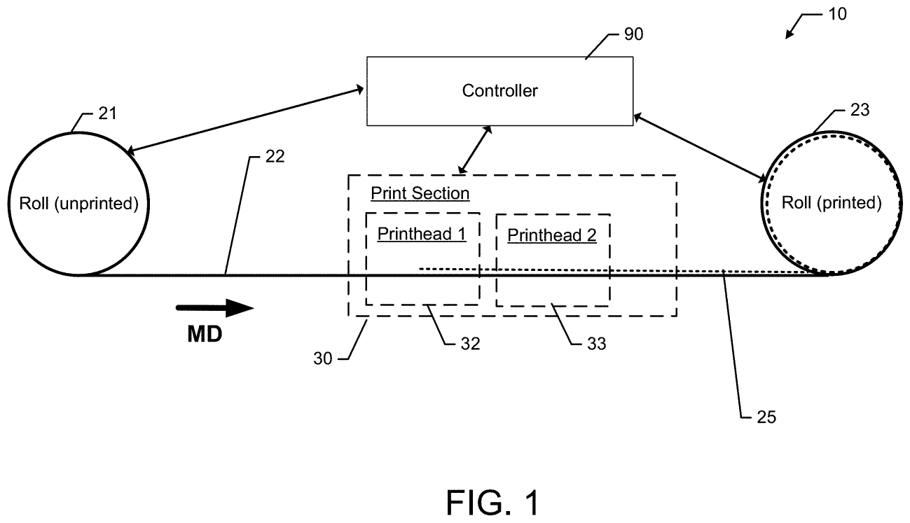

FIG. 1 shows a block diagram of an example printing and cleaning system 10 for printing on web product 22. The system 10 includes a controller 90 (including one or more controllers) that are used to control various operations of the system 10, such as described herein.

The controller 90 may be operably coupled with one or more components, including for example, the roll of unprinted web product 21 (or one or more devices/systems configured to control feeding of the roll 21), a print section 30, and a roll of printed web product 23 (or one or more devices/systems configured to control feeding of the roll 23). In some embodiments, the printed web product may be outputted in different forms, such as further processed or cut into sheets, etc. Depending on the components, the controller 90 may be operably coupled such as through use of solid-core wiring, twisted pair wiring, coaxial cable, fiber optic cable, mechanical, wireless, radio, infrared, etc. In this regard, depending on the components, the operable coupling may be through one or more intermediate controllers or mechanical coupling, such as used for controlling some components (e.g., controlling operation and/or feeding of the roll 21 of the web product). In some embodiments, the controller 90 may be configured to provide one or more operating signals to these components and to receive data from these components.

During print operations, the web product 22 may be passed along a web path in a machine direction (MD) into a print section 30 for printing thereon. In the print section 30, for example, one or more printheads (or rows of printheads) may print ink on the web product 22 to form printed web product 25. In the illustrated embodiment, printhead 1 32 prints ink of a first color onto the web product 22 while printhead 2 33 prints ink of second color onto the web product 22 to work together to form printed web product 25 with the desired image thereon. As understood to one of ordinary skill in the art, multiple printheads and different colors can be utilized to form the printed web product. Likewise, multiple rows of printheads can be utilized. Once the printed web product 25 is formed, it can be re-rolled at roll 23, such as for later transfer to other systems for continued manufacturing processes.

As described in more detail herein, the controller 90 provides logic and control functionality used during operation of various components/processes associated with the printing and cleaning system 10. In some embodiments, the functionality of the controller 90 may be distributed to several controllers that each provides more limited functionality to discrete portions of the various operations.

The controller 90 may comprise one or more suitable electronic device(s)/server(s) capable of executing described functionality via hardware and/or software control. In some embodiments, the controller 90 may include one or more user interfaces (not shown), such as for displaying information and/or accepting instructions. The controller 90 can be, but is not limited to, a microprocessor, microcomputer, a minicomputer, an optical computer, a board computer, a complex instruction set computer, an ASIC (application specific integrated circuit), a reduced instruction set computer, an analog computer, a digital computer, a molecular computer, a quantum computer, a cellular computer, a solid-state computer, a single-board computer, a buffered computer, a computer network, a desktop computer, a laptop computer, a personal digital assistant (PDA) or a hybrid of any of the foregoing.

The controller 90 may include one or more processors coupled to a memory device. Controller 90 may optionally be connected to one or more input/output (I/O) controllers or data interface devices (not shown). The memory may be any suitable form of memory such as an EPROM (Erasable Programmable Read Only Memory) chip, a flash memory chip, a disk drive, or the like. As such, the memory may store various data, protocols, instructions, computer program code, operational parameters, etc. In this regard, controller may include operation control methods embodied in application code. These methods are embodied in computer instructions written to be executed by one or more processors, typically in the form of software. The software can be encoded in any suitable language, including, but not limited to, machine language, assembly language, VHDL (Verilog Hardware Description Language), VHSIC HDL (Very High Speed IC Hardware Description Language), Fortran (formula translation), C, C++, Visual C++, Java, ALGOL (algorithmic language), BASIC (beginners all-purpose symbolic instruction code), visual BASIC, ActiveX, HTML (HyperText Markup Language), and any combination or derivative of at least one of the foregoing. Additionally, an operator can use an existing software application such as a spreadsheet or database and correlate various cells with the variables enumerated in the algorithms. Furthermore, the software can be independent of other software or dependent upon other software, such as in the form of integrated software. In this regard, in some embodiments, the controller 90 may be configured to execute computer program code instructions to perform aspects of various embodiments of the present invention described herein.

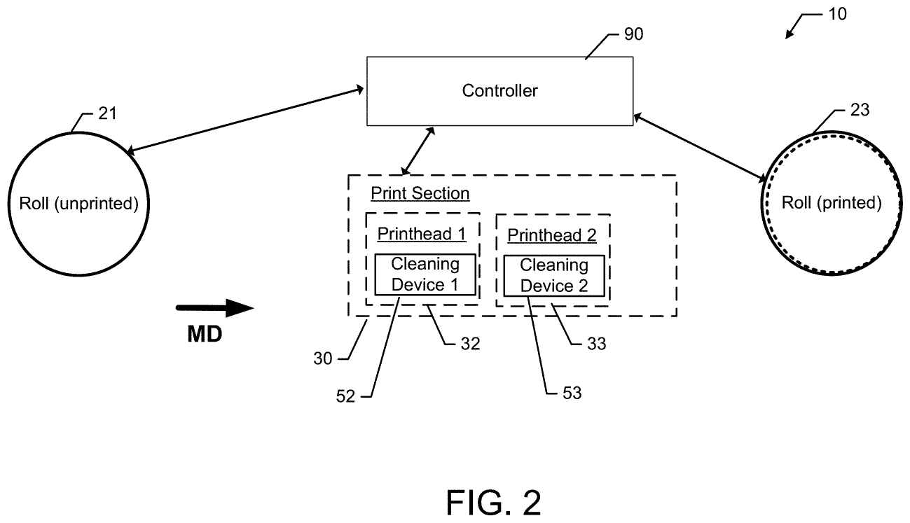

FIG. 2 illustrates the printing and cleaning system 10 with no web product in the print section 30. Instead, two example cleaning devices 52, 53 are being utilized to wipe clean the printheads 32, 33, respectively (although, in some embodiments, the cleaning devices may be configured to operate while the web product is in the system, such as if the printheads and cleaning devices are held at a distance above the web product). The controller 90 may be utilized to control operation of the cleaning devices 52, 53 to perform cleaning operations, such as described herein.

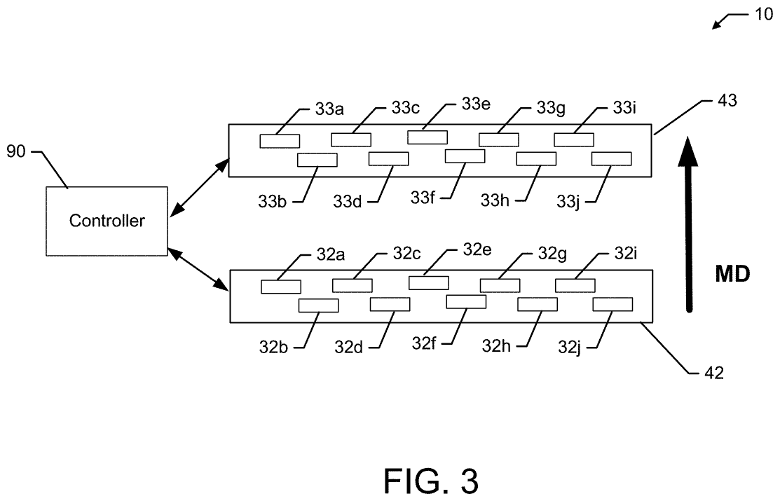

FIG. 3 illustrates a portion of the system 10 that includes two rows of printheads. The web product (not shown), while being printed, would travel along the machine direction (MD) past the first row of printheads 42 and then the second row of printheads 43 to receive corresponding ink thereon. The first row of printheads 42 includes individual printheads 32a-32j, while the second row of printheads 43 includes individual printheads 33a-33j. The controller 90 may operate one or more printheads to cause printing of ink onto the web product. Likewise, the controller 90 may perform other operations, such as controlling translation of the row of printheads to enable maintenance (or printing depending on the configuration of the print section).

As used herein, a row of printheads may be referred to as a printbar, and may be movable such as for maintenance (e.g., replacement of specific printheads) or printing. Further, while called a “row”, each row may comprise offset printheads that may slightly overlap in the machine direction to ensure that each part of the web product in the width direction passing by the row of printheads may receive ink if so desired. While the illustrated and described embodiment includes 10 printheads in each “row” any number of printheads is contemplated (e.g., 12 printheads, 24 printheads, etc.). Likewise, as detailed herein, any number of “rows” can be utilized, such as two rows for each color used in the printing process.

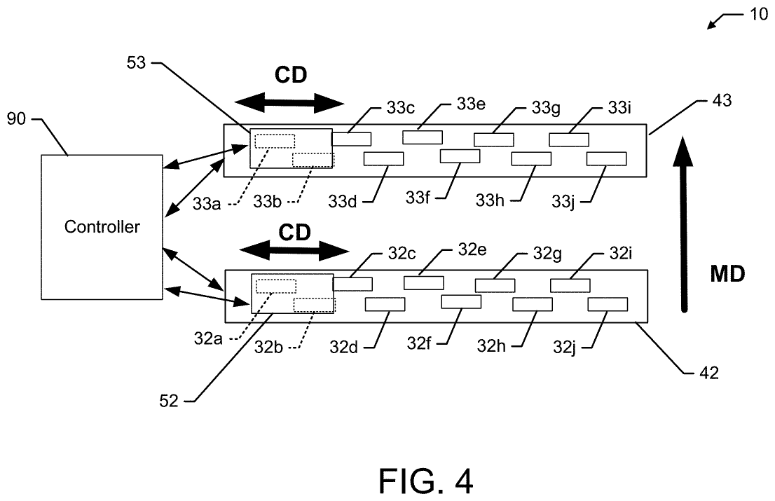

FIG. 4 shows a schematic representation of an example printhead cleaning system 10 that uses cleaning devices 52, 53 to perform a cleaning operation by wiping across the printheads in the two rows of printheads 42, 43. In the illustrated embodiment, the controller 90 is operably connected to the cleaning devices 52, 53 and can operate the cleaning devices 52, 53 to wipe across the respective rows of printheads 42, 43 to clean the printheads. As illustrated, the first cleaning device 52 may translate (e.g., via a translation device, such as via a motor, etc.) across the first row of printheads 42 (e.g., in the cross direction (CD)) cleaning each of the printheads 32a-32j. Likewise, the second cleaning device 53 may translate (e.g., via a translation device, such as via a motor, etc.) across the second row of printheads 43 (e.g., in the cross direction (CD)) cleaning each of the printheads 33a-33j.

Though not shown, in some embodiments, additional cleaning devices can be used to clean the printheads. For example, there may be two or more cleaning devices for the same row of printheads, such as one cleaning device moving from the left edge to the middle and another cleaning device moving from the right edge to the middle so as to clean each printhead in the row of printheads.

As detailed herein, in some embodiments the cleaning devices may include one or more wipes for being wiped across the printheads. In some embodiments, a cleaning additive may be applied to the wipe (or the portion of the wipe about to be wiped across the printhead). The cleaning additive may be any type of fluid or non-wetted cleaning product. In this regard, some embodiments of the present invention contemplate different types of fluid that could be utilized. In a preferred embodiment, water (e.g., distilled water) or another solvent is used. Additionally, in some embodiments, additives, such as cosolvents could be added to the water (or other solvent) to enhance cleaning operations. In some embodiments, different ingredients may be added to the fluid, such as to help increase effectiveness of the cleaning additive. For example, surfactants and other cleaning fluids can be added/applied to the wipe.

Depending on the desired configuration of the wipe, the cleaning additive may be designed to be (at least partially) absorbed into the wipe or may be adsorbed with the wipe. In this regard, in some embodiments, providing for adsorbing of the cleaning additive fluid may cause the cleaning additive fluid to be more present on the outer surface of the wipe and, therefore, be positioned to interact with the printhead when being wiped across the printhead. In some embodiments, the wipe may exhibit wicking properties to help encourage the cleaning additive to rise to the outer surface of the wipe to be present for interaction with the printhead when being wiped across the printhead. Additionally or alternatively, as indicated herein, in some embodiments, the wipe of the cleaning device may be pre-moistened, such that the cleaning additive is pre-applied to the wipe.

In some embodiments, the cleaning additive may be a non-wetted cleaning product. For example, the non-wetted (or dry) cleaning product may include various small particles, such as of minerals, fine steel wool, copper, nylon or metal. In addition, small amounts of surfactants may be included in the non-wetted cleaning product. Additionally or alternatively, as indicated herein, in some embodiments, the wipe of the cleaning device may have the cleaning additive pre-applied, such that the non-wetted cleaning product is pre-applied to the wipe.

In some embodiments, various cleaning additives may be used depending on the type of ink being used by the printheads. In this regard, different inks may be formed of different compositions, which may be better cleaned with different cleaning additives. Along similar lines, in some embodiments, various cleaning additives may be used depending on the paper type used in the prior print runs or planned for use in future print runs. In some embodiments, example print systems may be utilized for various types of paper (e.g., white top, kraft paper, masterliner, etc.) and/or may be utilized with coated or uncoated paper. Different types of paper often create different types of issues that may arise with the printheads. Likewise, printing on uncoated versus coated paper may further present different types of issues (e.g., printing on uncoated paper may tend to produce shavings that clog the printheads). Accordingly, the system may take this information into account and adapt the cleaning operation accordingly, such as automatically. Additionally or alternatively, the system may notify a user as to a preferred option or options for which cleaning additives to have applied to the cleaning device for more effective cleaning of the printheads. In this regard, the system may apply or recommend a desired cleaning additive based on one or more factors (e.g., the print quality of the printhead being cleaned, recent or future paper types being printed on, recent or future ink types being printed with, age of the printhead, etc.).

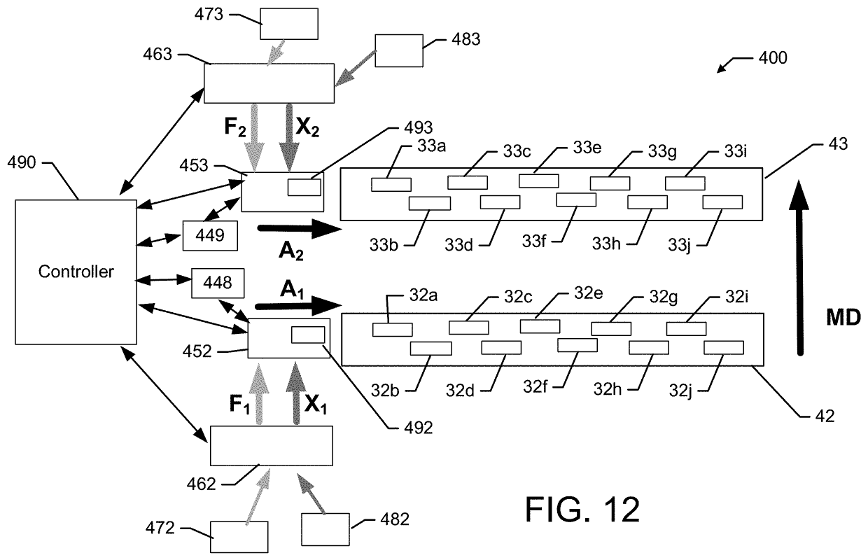

In some embodiments, the system may be configured to perform the cleaning operation utilizing one or more cleaning assistance features. Such cleaning assistance features may be provided separately or in conjunction with use of cleaning additives. Example cleaning assistance features include applying one or more of heat, vibration, or sound before or while the cleaning device is being wiped across the printhead. In some embodiments, the cleaning assistance features may be applied to the cleaning device, the wipe of the cleaning device, the printhead(s), and/or the print system as a whole. An example system that may be configured to provide cleaning assistance features is shown and described with respect to FIG. 12. Similar to the cleaning additives, in some embodiments, the system may be configured to automatically apply or recommend a desired cleaning assistance feature, such as based on one or more factors (e.g., the print quality of the printhead being cleaned, recent or future paper types being printed on, recent or future ink types being printed with, age of the printhead, etc.).

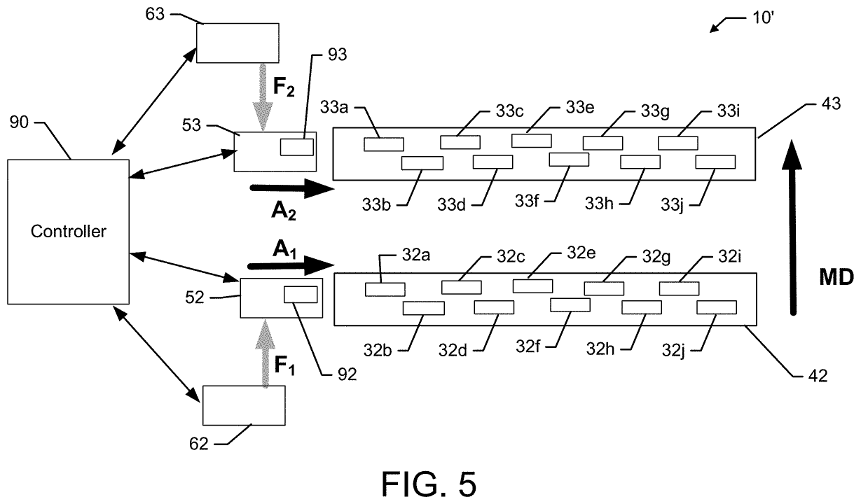

As an example, FIG. 5 shows a schematic representation of another example printhead cleaning system 10′ that provides fluid from fluid application devices 62, 63 to the cleaning devices 52,53 used to perform a cleaning operation on the printheads in the two rows of printheads 42, 43. Such fluid may be applied to a specific portion of the wipe and through use of the controller 90. As illustrated in FIG. 5, fluid from the first fluid application device 62 may be applied (e.g., sprayed along direction F₁) onto the wipe of the first cleaning device 52 prior to the first cleaning device 52 being translated across the first row of printheads 42 (e.g., along arrow A₁). Similarly, fluid from the second fluid application device 63 may be applied (e.g., sprayed along direction F₂) onto the wipe of the second cleaning device 53 prior to the second cleaning device 53 being translated across the second row of printheads 43 (e.g., along arrow A₂).

In some embodiments, the system may be configured to monitor moisture within the system, such as along the printheads and/or within the cleaning devices. For example, sensors 92, 93 may be positioned within respective cleaning devices 52, 53 and configured to measure an amount of moisture present within the cleaning devices 52, 53 (although, in some embodiments, the sensors could be positioned outside of the cleaning devices). Such data could be used to determine, such as via the controller 90, whether too much moisture is present within the printing and cleaning system 10, 10′—which may, in some cases, cause undesirable effects on the printing and cleaning system 10, 10′.

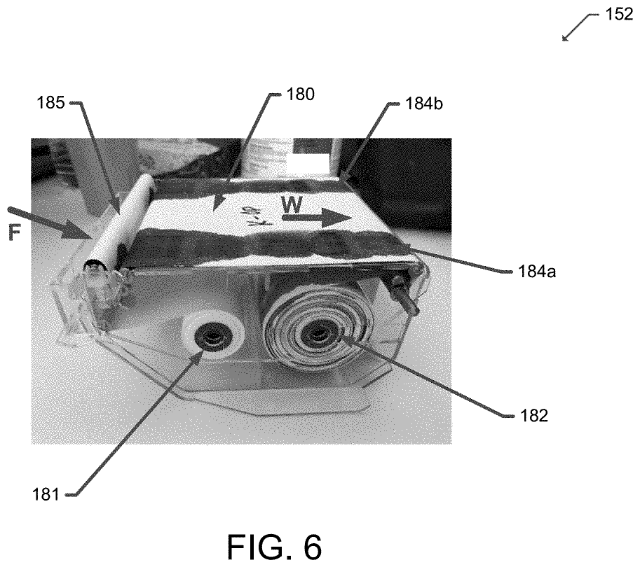

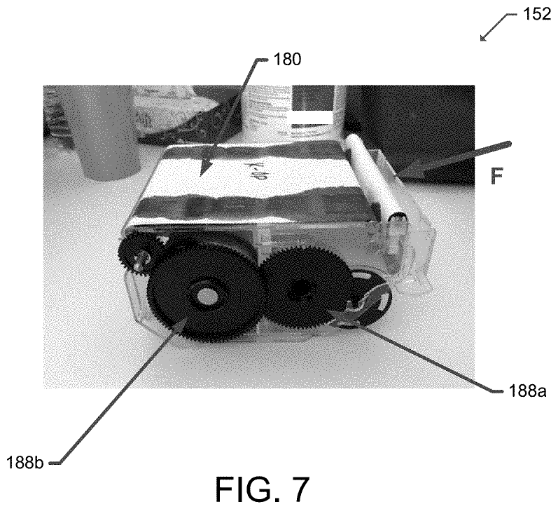

FIGS. 6-7 show an example cleaning device 152 that has been partially used. The cleaning device 152 includes a web wipe 180 that extends along a web path leading from a first roll holder 181 (unused portion) to a second roll holder 182 (used portion). One or more gears 188a, 188b can be driven by one or more motors (e.g., motors present in the printing system and controlled by the controller 90) to cause the web wipe to advance (e.g., along arrow W)—providing unused portions for use with wiping across the printheads as the cleaning device approaches the printhead. Once the unused web wipe is sufficiently used up (and now present on the second roll holder), the cleaning device 152 may be replaced, such as with a cleaning device with all unused web wipe.

With reference to FIG. 6, the portion of the wipe that is planned for wiping across the printhead is presented at a certain position (e.g., a printhead contact region 185) along the web path. In some embodiments, such a region may be raised relative to the remainder of the cleaning device to ensure that the region contacts the printhead. In some embodiments, one or more tension rollers or curves may be used to create a desired tension that can be utilized to form a sufficient friction between the portion of the wipe and the printhead as the printhead is wiped clean.

In some embodiments, the cleaning additive (e.g., fluid or non-wetted cleaning product) may be applied along the web path upstream of the printhead contact region 185 (e.g., the cleaning additive may be applied where arrow F is pointing). In this regard, as the cleaning device 152 is translated across the row of printheads and the web wipe is unwound, the portion of the wipe presented in the printhead contact region 185 for wiping along the printhead has been applied with the cleaning additive.

In some embodiments, the system 10, such as via the controller 90, may be configured to operate the printheads to “spit” some ink as the wipe with the cleaning additive already applied wipes along the printhead. This operation may help clear the printhead and remove debris/dirt from the printhead. Residue of such ink is shown along each side of the illustrated web wipe at 184a and 184b. Notably, the spaced apart relation of 184a and 184b corresponds to the offset nature of the row of printheads, as illustrated, for example, in FIGS. 3-5.

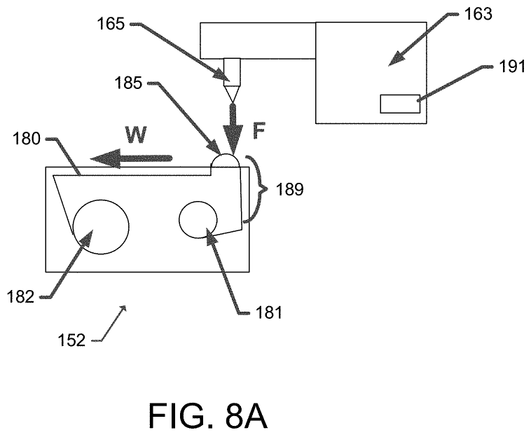

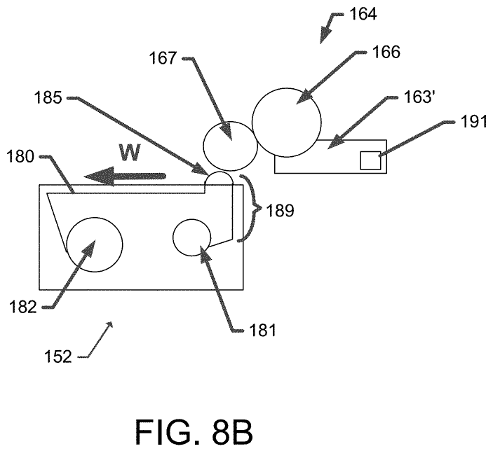

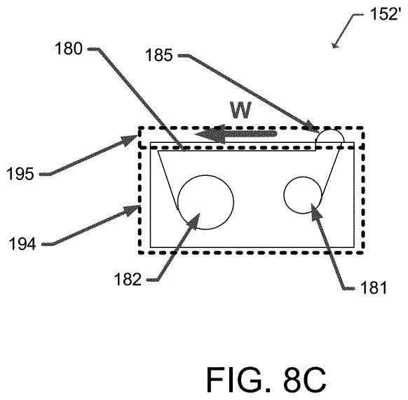

Application of the cleaning additive may be accomplished in any number of suitable ways. For example, in some embodiments, the wipe may be provided within the cleaning device with the cleaning additive pre-applied (e.g., pre-moistened). Additionally or alternatively, the cleaning additive may be applied prior to or in conjunction with the cleaning operation (e.g., manually, with a spray nozzle, with a metered-roller, or with another feature). FIGS. 8A-8C illustrate different application options for various example systems described herein.

FIG. 8A illustrates an example cleaning additive application device 163 with a spray nozzle 165. The cleaning additive application device 163 is configured to spray one or more types of cleaning additive through spray nozzle 165 (along arrow F) onto a portion of a wipe 185 of the cleaning device 152. In some embodiments, the cleaning additive application device 163 may be connected to a supply of the cleaning additive (e.g., a reservoir). In some such embodiments that utilize a reservoir, a sensor 191 may be used to sense the level of cleaning additive remaining in the reservoir. This data may be sent to the controller for monitoring accordingly (e.g., notifying a user, determining a need for more cleaning additive, etc.).

As detailed herein, the portion of the wipe 185 with the cleaning additive thereon may be wiped across the printhead(s) during the cleaning operation. During the cleaning operation, the web wipe 180 may be rolled up from the first roll holder 181 to the second roll holder 182 (e.g., along arrow W) as the cleaning device moves across a row of printheads, for example. Thus, in some embodiments, it may be desirable to spray the cleaning additive such that it covers a length of the web wipe before and leading to the contact area 185 (e.g., indicated as 189). For example, it has been found that a ˜1 mm-3 mm drop of distilled water provides for a sufficient amount of coverage.

FIG. 8B illustrates another example cleaning additive application device 164 that utilizes an application roller 167 for applying the cleaning additive. The cleaning additive application device 164 is configured to apply the cleaning additive onto a portion of a wipe 185 of the cleaning device 152 via the application roller 167 (e.g., a metered roller). In the illustrated embodiment, a pickup roller 166 picks up the cleaning additive from the supply 163′ and transfers it to the application roller 167. The application roller 167 then transfers the cleaning additive to the wipe as it rotates. In some embodiments, a sensor 191 may be used to sense the level of cleaning additive remaining in the supply 163′. This data may be sent to the controller for monitoring accordingly (e.g., notifying a user, determining a need for more cleaning additive, etc.).

As detailed herein, the portion of the wipe 185 with the cleaning additive thereon may be wiped across the printhead(s) during the cleaning operation. During the cleaning operation, the web wipe 180 may be rolled up from the first roll holder 181 to the second roll holder 182 (e.g., along arrow W) as the cleaning device moves across a row of printheads, for example. Thus, in some embodiments, it may be desirable to apply a sufficient amount of the cleaning additive such that it runs down and applies to a length of the web wipe before and leading to the contact area 185 (e.g., indicated as 189).

FIG. 8C illustrates another example cleaning device 152′ that includes wipes that are pre-applied with cleaning additive (e.g., the wipes are pre-moistened). In some embodiments, an enclosure 194 may be provided around the cleaning device 152′ (or at least the web wipe 180) to prevent the wipe from drying out. In some embodiments, the enclosure 194 may include a top 195 that is configured to transition from a closed configuration to an open configuration to reveal at least a portion of the wipe (e.g., at 185) for interaction with the printhead(s) during the cleaning operation.

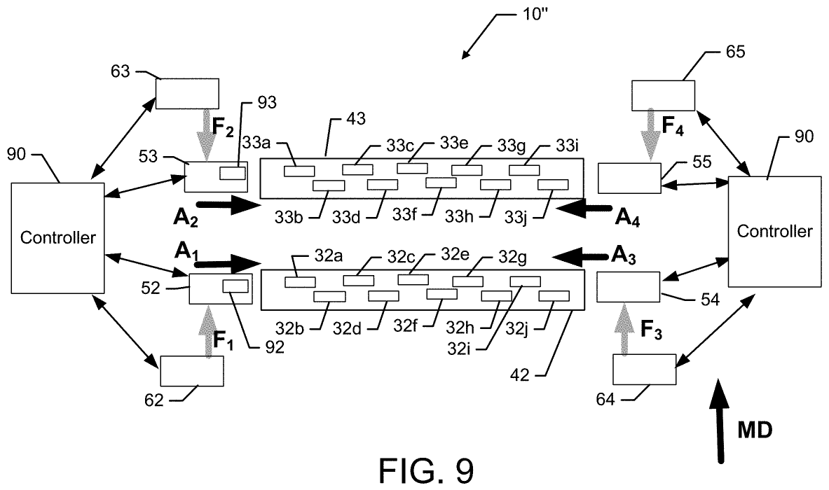

FIG. 9 shows a schematic representation of another example printhead cleaning system 10″ that is similar to the printhead cleaning system 10′ in FIG. 5, but includes a second cleaning device 54, 55 on the other side of each row of printheads 42, 43, respectively. The controller 90 (shown split up for ease of illustration) may control operation of the second cleaning devices 54, 55 and the corresponding application of cleaning additive thereto (e.g., along arrows F₃ and F₄ from fluid application devices 64, 65, respectively).

In some embodiments, the cleaning devices 52, 53 on the left side of the rows of printheads 42, 43 may translate along the left half of the rows of printheads 42, 43 (e.g., to cover 32a-32e and 33a-33e), respectively, while the second cleaning devices 54, 55 on the right side may translate along the right half of the rows of printheads 42, 43 (e.g., to cover 32f-32j and 33f-33j), respectively. In such example embodiments, the cleaning operation may be performed in half the time, for example.

Additionally or alternatively, in some embodiments, the system may be designed to enable multiple passes of the cleaning devices across the rows of printheads 42, 43 during a cleaning operation. For example, the first cleaning devices 52, 53 may perform a first pass across the rows of printheads 42, 43, respectively. Thereafter, the second cleaning devices 54, 55 may perform a second pass across the rows of printheads 42, 43, respectively. In some such embodiments, different configurations of cleaning additives and/or cleaning assistance features may be applied for each pass. For example, a fluid cleaning additive could be applied to the first cleaning devices 52, 53, while the second cleaning devices 54, 55 are dry—therefore forming a wet and dry pass for improved cleaning of the printheads. Other combinations of cleaning additives and/or cleaning assistance features are also contemplated (e.g., applying a non-wetted cleaning product wipe and then a fluid applied wipe; applying a fluid applied wipe and then a heated dry wipe; etc.). Example components for applying cleaning assistance features are shown and described in FIG. 12, for example.

In some embodiments, a single cleaning device may pass over the row of printheads twice instead of having cleaning devices on both sides of the row of printheads. In such a regard, in some embodiments, the web wipe may be taken up (e.g., via the second roll holder 182) after or during each pass, such that an unused portion of the web wipe is present for receipt of a different cleaning additive for the second pass of the cleaning operation.

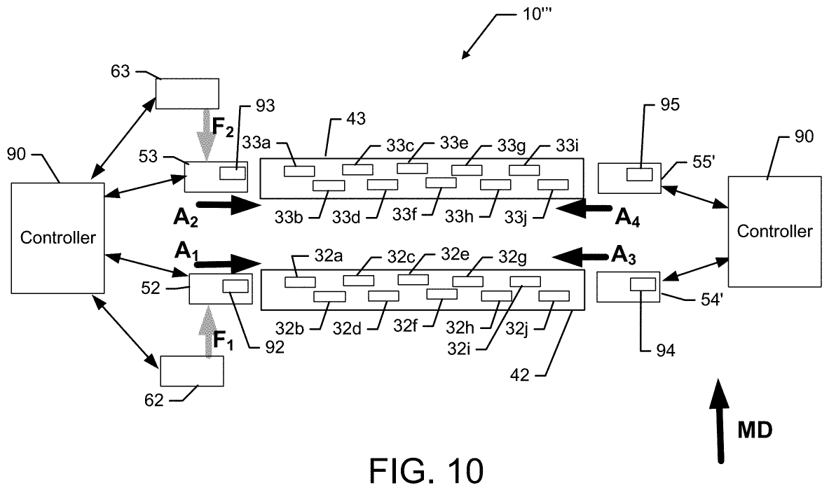

FIG. 10 illustrates an example printhead cleaning system 10″′ that is similar to the system 10″ shown in FIG. 9, except that the second cleaning devices 54′, 55′ are not configured to receive application of a cleaning additive. Such a system 10″′ may be useful in providing a dry wipe for a second pass during the cleaning operation, such as described above.

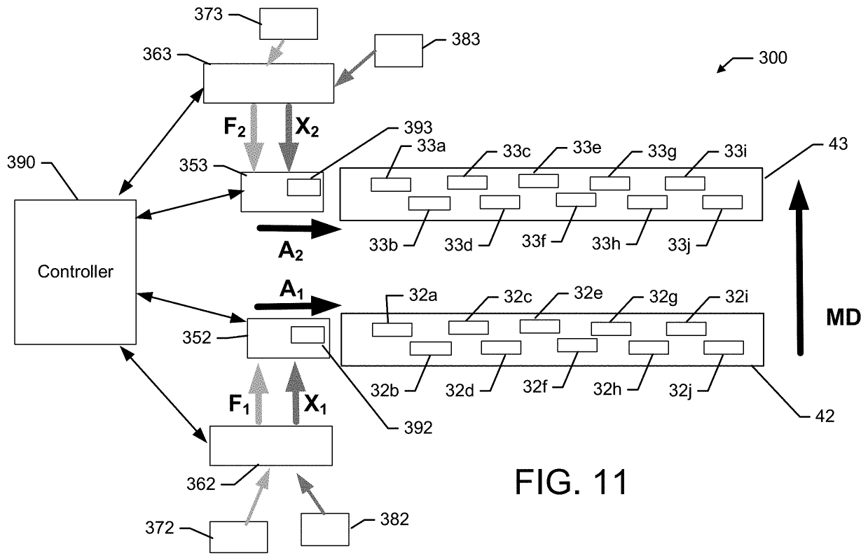

FIG. 11 illustrates an example printhead cleaning system 300 that is similar to the system 10 shown in FIG. 5, except that the cleaning devices 352, 353 may receive one or more different cleaning additives from their respective cleaning additive application devices 362, 363. In this regard, the controller 390, like the controller 90, may control operation of the cleaning devices 352, 353 and the cleaning additive application devices 362, 363. Notably, the cleaning additive application devices 362, 363 may each be configured to enable different types of cleaning additive to be applied. For example, a fluid may be applied (e.g., sprayed along arrows F₁ and F₂, respectively) and/or a non-wetted dry cleaning product may be applied (e.g., sprayed along arrows X₁ and X₂, respectively). Such different cleaning additives may be taken from respective reservoirs 372, 373 and 382, 383. The cleaning devices 352, 353 may each also include sensors 392, 393, such as may be similar to sensors 92, 93.

Although the above example provides two different cleaning additives, more or different cleaning additives could be applied. In this regard, such an example system 300 may enable optionality for determining and providing a desirable cleaning operation. Further, such a system 300 could apply multiple passes (as described above), such as with the single cleaning device for each row of printheads, or with multiple cleaning devices for each row of printheads (similar to what is shown in FIGS. 9-10).

FIG. 12 illustrates another example printhead cleaning system 400 that is similar to the printhead cleaning system 300 shown and described with respect to FIG. 11. In this regard, the cleaning devices 452, 453 may receive one or more different cleaning additives from their respective cleaning additive application devices 462, 463. The controller 490, like the controller 90, may control operation of the cleaning devices 452, 453 and the cleaning additive application devices 462, 463. The cleaning additive application devices 462, 463 may each be configured to enable different types of cleaning additive to be applied. For example, a fluid may be applied (e.g., sprayed along arrows F₁ and F₂, respectively) and/or a non-wetted dry cleaning product may be applied (e.g., sprayed along arrows X₁ and X₂, respectively). Such different cleaning additives may be taken from respective reservoirs 472, 473 and 482, 483. The cleaning devices 452, 453 may each also include sensors 492, 493, such as may be similar to sensors 92, 93.

Notably, however, the printhead cleaning system 400 also includes cleaning assistance feature devices 448, 449 that can be operated/instructed by the controller 490. In this regard, the cleaning assistance feature devices 448, 449 may be configured to provide one or more cleaning assistance features to the cleaning devices 452, 453 (although the cleaning assistance features could be provided to the row of printheads 42, 43 and/or the cleaning additive application devices 462, 463). Some example cleaning assistance features include providing one or more of heat, cold, vibration, and sound. For example, a temperature change element may be used to heat and/or cool the wipe of the cleaning device and/or an applied cleaning additive for use during the cleaning operation. As another example, a vibration generator may generate vibrations as the cleaning device is wiped across the printhead, such as may help “knock-off” debris or dried ink. Likewise, a sound generator may generate sound that is used to increase cleaning effectiveness.

In some embodiments, the wipe may be substituted for other cleaning devices, such as a bristle brush, a squeegee, a sponge, steel wool, etc. In some embodiments, mechanisms may be provided to manipulate such cleaning devices (e.g., rotate the bristle brush, ring out the sponge, etc.), such as it is wiped across the printhead(s). Such example cleaning devices may provide additional cleaning effect depending on the configuration and desires of the printhead cleaning system.

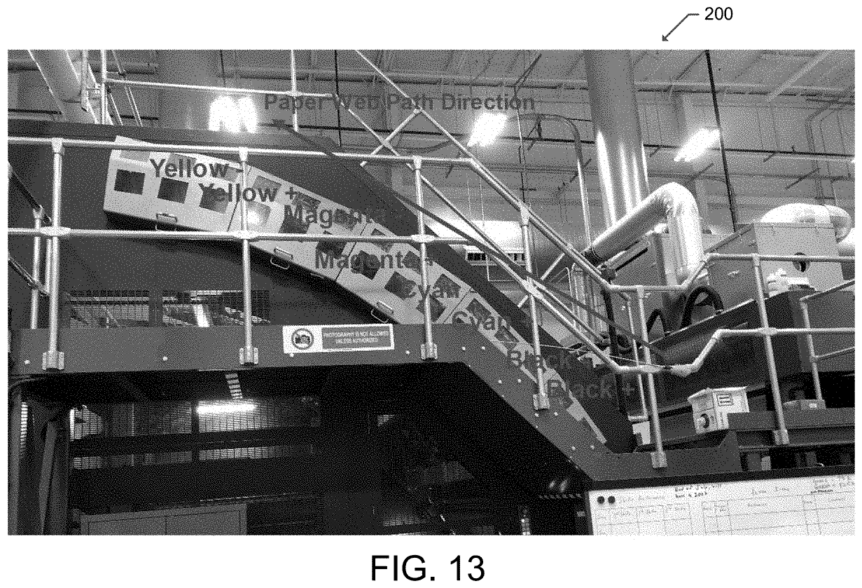

FIG. 13 shows an example printing system 200 and corresponding web path for the web product passing by rows of printheads for printing thereon. As illustrated, the web product passes through the printing section from right to left. There are two rows of printheads for each corresponding ink color: black+; black−; cyan+; cyan−; magenta+; magenta−; yellow+; and yellow−. Example embodiments contemplate providing various described cleaning devices for each row of printheads.

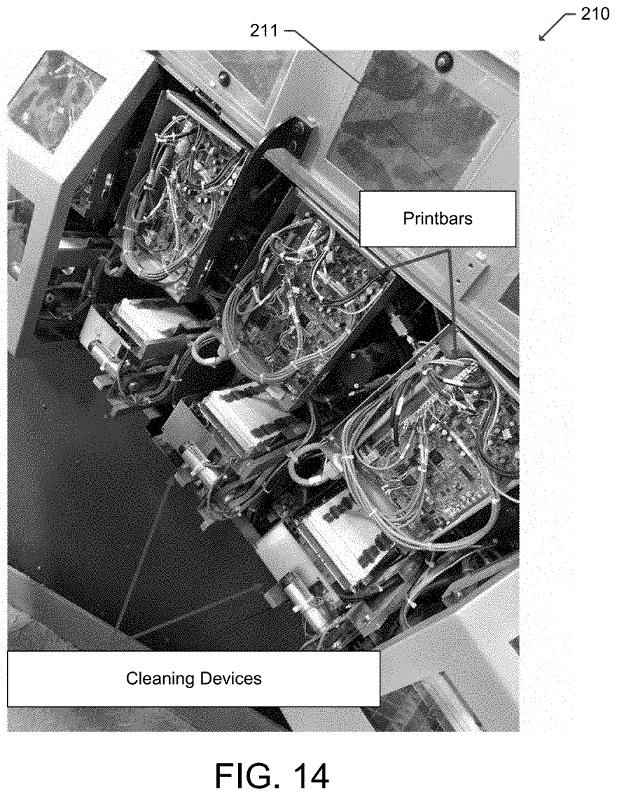

FIG. 14 shows a portion of the printing system 210 with a door 211 opened to enable maintenance on the printheads (labeled as Printbars in the image) and cleaning devices. With the door 211 opened, a maintainer may pull out the printbars to replace or service the printheads and/or the cleaning devices to replace or service the cleaning devices (or apply the fluid in some cases).

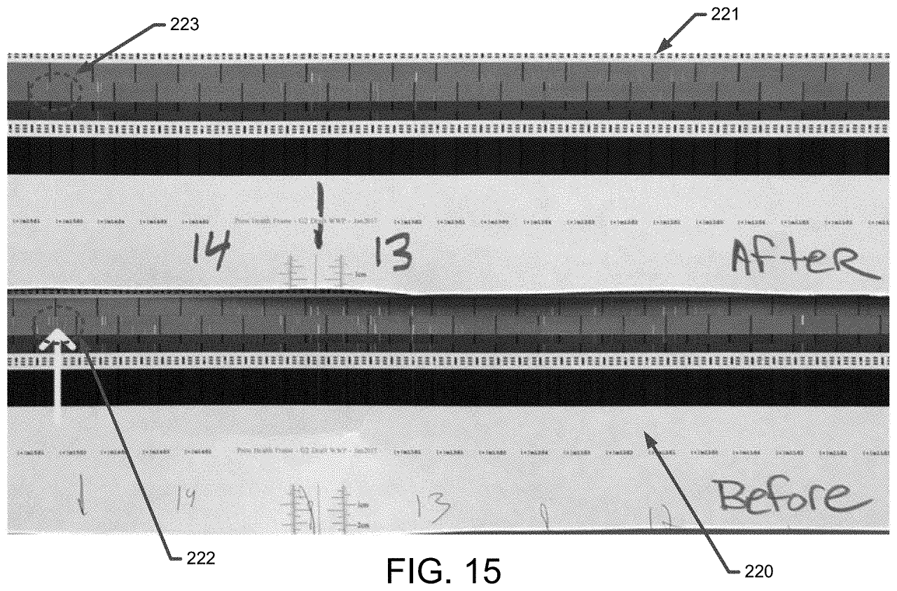

FIG. 15 illustrates a before 220 and after 221 rendering of print quality of a row of printheads, where the bottom half 220 shows the print quality after being cleaned with a wipe without any cleaning additive applied, and where the top half 221 shows the print quality after being cleaned with example cleaning devices that included a wipe with a cleaning additive in the form of distilled water applied. The arrow points to various print defects (white lines) visible at 222 in the printout of the before rendering 220. Notably, however, after a cleaning operation is performed with a cleaning device that includes a wipe with the cleaning additive applied, the print quality increases even without replacing the printheads. For example, there is a significant reduction in the number of print defects (white lines) at the same location 223.

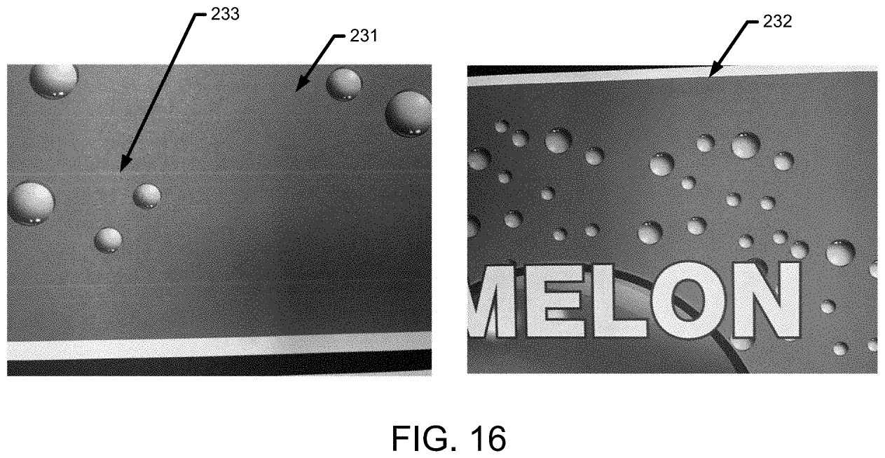

FIG. 16 illustrates a before and after rendering of print quality on printed web product, where the left image 231 shows the print quality after being cleaned with a wipe with any cleaning additive applied, and where the right image 232 shows the print quality after being cleaned with example cleaning devices that included a wipe with cleaning additive in the form of distilled water applied. Notably, the various white or faded streaks shown at 233 in the left image 231 are not present in the right image 232.

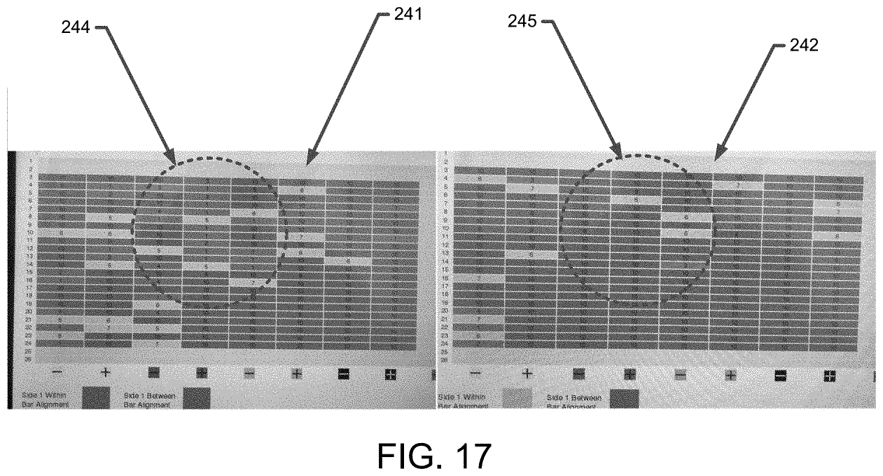

FIG. 17 illustrates a before and after image of printhead quality scores, where the left image 241 shows the print quality scores after being cleaned with a wipe with any cleaning additive applied, and where the right image 242 shows the print quality scores after being cleaned with example cleaning devices that included a wipe with cleaning additive in the form of distilled water applied. Notably, each colored block corresponds to a printhead. For example, the far left two rows are for the color yellow. The printhead position along the width direction of the web product corresponds to 3 to 24 (moving left to right). Further, the color of each block corresponds to a print quality score (e.g., red indicates a low print quality score, yellow indicates a medium print quality score, and green indicates a good print quality score). With reference to various blocks in the magenta and cyan rows (indicated by 244), many of the printheads in the left image 241 received low print quality scores (e.g., red). However, after a cleaning operation with a cleaning device that included a wipe with the cleaning additive applied, the same printheads tested with higher print quality scores—showing more green colored blocks in the right image 242 in the magenta and cyan rows (indicated by 245).

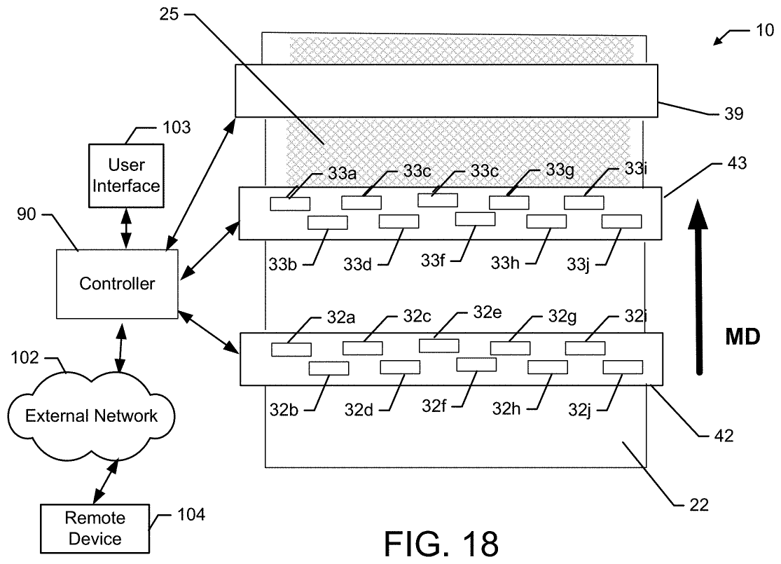

FIG. 18 illustrates the example printhead cleaning system 10 with the controller 90 connected to a user interface 103 and an external network 102. Connection to the external network 102 enables communication between the controller 90 and various remote devices, such as remote device 104. In this regard, the system 10 may be configured for performing various operations described herein, such as monitoring printhead performance and performing cleaning operations.

In some embodiments, the system 10 may be configured to monitor printhead performance and determine print quality of each printhead, such as illustrated in the example printhead print quality read out in FIG. 17. For example, the system 10 may include one or more sensors 39 that are configured to determine a print quality of the ink 25 applied to the web product 22. Such print quality may be based on various factors, such as the expected color profile, density of ink applied, the presence of white streaks, etc. Using the position of the sensor 39 along the width of the web product 22 may enable correlation to a corresponding printhead position, and using the sensed color may indicate which color printhead applied the corresponding ink. Thus, the system 10 may be configured to determine the print quality and the corresponding printhead. From that information, the system 10 may be configured to determine a print quality for the corresponding printhead.

In some embodiments, the system 10 may be configured to compare the determined print quality of the printhead to one or more threshold print quality levels to determine if various actions should be taken. For example, if the determined print quality is below a threshold print quality level, then the system 10 may perform one or more cleaning operations (or schedule performance of one or more cleaning operations). Depending on various factors (e.g., the previous or future planned paper being printed on, the previous or future planned ink being used, age of the printhead, etc.), the system 10 may determine a cleaning operation tailored to provide a more effective cleaning of the specific printhead (or a group of printheads). For example, the system 10 may determine that multiple passes of the cleaning device is appropriate, where the first pass is with a wipe with applied cleaning additive of fluid and the second pass is with a wipe without any cleaning additive applied. Likewise, cleaning assistance features could also be used, as described herein. Other options are also contemplated, such as described herein.

In some embodiments, there may be multiple threshold print quality levels, such that if a first threshold print quality level is reached (e.g., moderate print quality), then a first cleaning operation is performed; but if a second (e.g., lower) threshold print quality level is reached (e.g., low print quality), then a second (e.g., more severe) cleaning operation is performed. In this regard, the severity of the cleaning operation may be based on, for example, use of different cleaning additives (e.g., adding surfactant may be more severe than using just distilled water); use of a cleaning additive versus not using a cleaning additive; use of cleaning assistance features (e.g., adding vibration may be more severe); and/or use of multiple passes of the cleaning device (although other variations are contemplated).

In some embodiments, the system 10 may be configured to determine and cause a notification to be provided to a user (e.g., an operator, etc.), such as in response to the comparison indicating that a determined print quality is below a threshold print quality level. In this regard, the notification may indicate any desirable information, such as related to the subject printhead (e.g., which printhead, the print quality, the planned cleaning operation, suggested cleaning operation steps/cleaning additives/cleaning assistance features, a need to replace the printhead, etc.). Such a notification could be, for example, presented on the user interface 103 and/or provided to the user via the external network 102, such as to a remote device 104.

In some embodiments, the notification may be applied in conjunction with or in lieu of performance of the cleaning operation. In some embodiments, the notification may offer a suggestion to run a cleaning operation. Suggested cleaning additives, cleaning assistance features, number of passes, etc., could be included in the notification. In some embodiments, the system 10 may provide an option for the user to select to have a cleaning operation scheduled accordingly.

In some embodiments, determination as to whether to apply the cleaning operation and/or send a notification may depend on the severity of the determined print quality. In this regard, a moderate print quality may result in performance of a cleaning operation, whereas a critically low or low print quality may result in sending a notification. In some embodiments, the system 10 may first try a cleaning operation, then sense the print quality again and, thereafter, determine an appropriate response. This may include sending a notification and/or performing another cleaning operation. For example, if after performing a cleaning operation, the system determines that the print quality hasn't changed or is below a certain threshold print quality level then the system may perform another cleaning operation (e.g., one that may be more severe) and/or may send a notification. In some embodiments, this notification may include an indication for the user to replace the printhead.

### Example Flowchart(s)

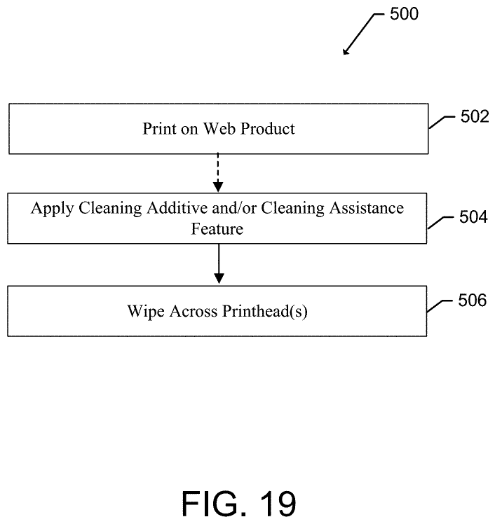

Embodiments of the present invention provide methods, apparatuses and computer program products for controlling the various components/features according to various systems described herein. Various examples of the operations performed in accordance with embodiments of the present invention will now be provided with reference to FIGS. 19-22.

FIG. 19 illustrates a flowchart according to an example method for printing on web product and cleaning printheads according to an example embodiment. The operations illustrated in and described with respect to FIG. 19 may, for example, be performed by, with the assistance of, and/or under the control of one or more of the controller 90, 390, 490 and other components/features of the systems 10, 10′, 10″, 10′″, 300, 400 described herein.

The method 500 may include printing on the web product at operation 502. At operation 504, the method may comprise applying cleaning additive to the wipe of the cleaning device (e.g., manually or automatically) and/or applying one or more cleaning assistance features. At operation 506 (which may be performed in conjunction with operation 504), the method comprises wiping the wipe across the printhead for performing the cleaning operation.

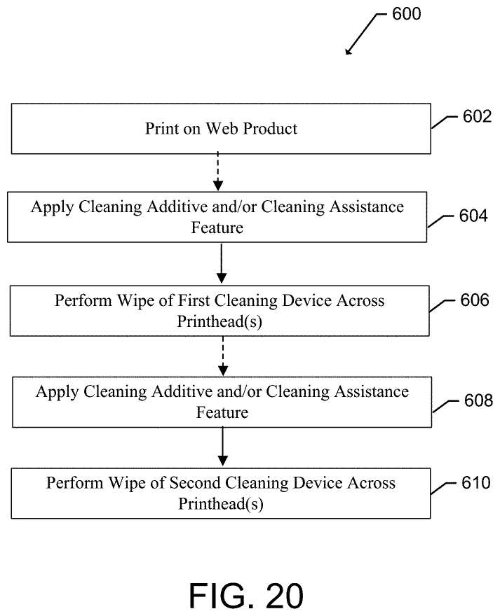

FIG. 20 illustrates a flowchart according to an example method for printing on web product and cleaning printheads according to another example embodiment. The operations illustrated in and described with respect to FIG. 20 may, for example, be performed by, with the assistance of, and/or under the control of one or more of the controller 90, 390, 490 and other components/features of the systems 10, 10′, 10″, 10′″, 300, 400 described herein.

The method 600 may include printing on the web product at operation 602. At operation 604, the method may comprise applying cleaning additive to a wipe of a first cleaning device (e.g., manually or automatically) and/or applying one or more cleaning assistance features. Then, at operation 606 (which may be performed in conjunction with operation 604), the method comprises wiping the wipe of the first cleaning device across the printhead for performing the cleaning operation. At operation 608, the method includes applying cleaning additive to a wipe of a second cleaning device (e.g., manually or automatically) and/or applying one or more cleaning assistance features. At operation 610 (which may be performed in conjunction with operation 608), the method comprises wiping the wipe of the second cleaning device across the printhead for performing the cleaning operation.

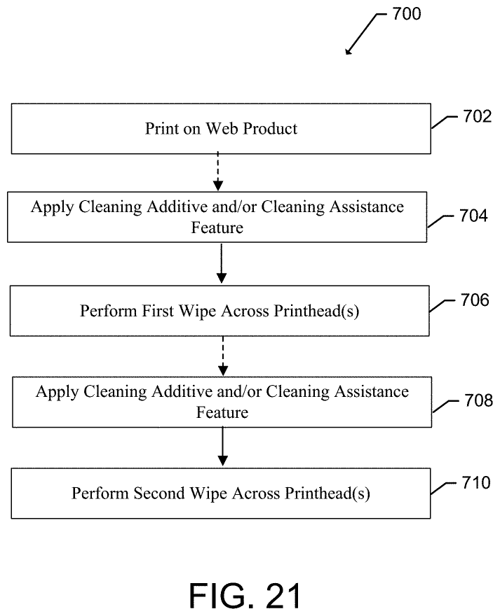

FIG. 21 illustrates a flowchart according to an example method for printing on web product and cleaning printheads according to another example embodiment. The operations illustrated in and described with respect to FIG. 21 may, for example, be performed by, with the assistance of, and/or under the control of one or more of the controller 90, 390, 490 and other components/features of the systems 10, 10′, 10″, 10′″, 300, 400 described herein.

The method 700 may include printing on the web product at operation 702. At operation 704, the method may comprise applying cleaning additive to a first portion of a wipe of a cleaning device (e.g., manually or automatically) and/or applying one or more cleaning assistance features. Then, at operation 706 (which may be performed in conjunction with operation 704), the method comprises wiping the first portion of the wipe of the cleaning device across the printhead for performing the cleaning operation. At operation 708, the method includes applying cleaning additive to a second portion of the wipe of the cleaning device (e.g., manually or automatically) and/or applying one or more cleaning assistance features. At operation 710 (which may be performed in conjunction with operation 708), the method comprises wiping the second portion of the wipe of the cleaning device across the printhead for performing the cleaning operation.

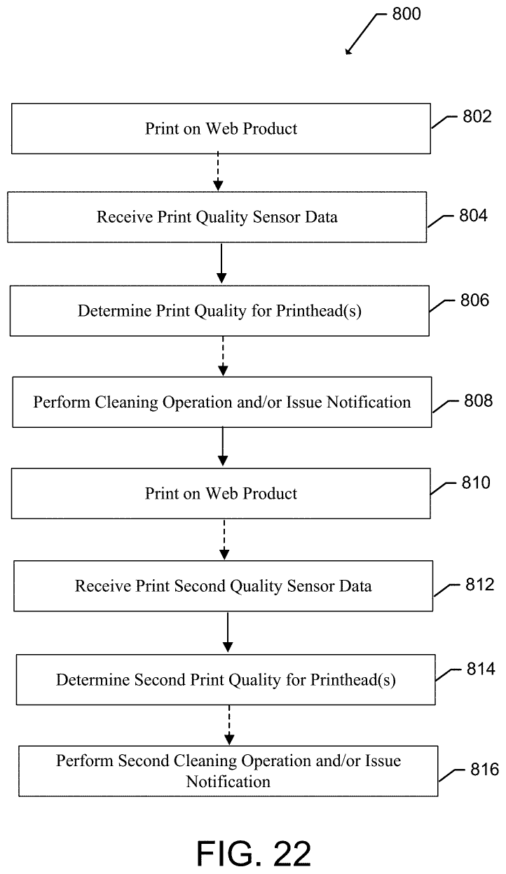

FIG. 22 illustrates a flowchart according to an example method for monitoring printhead print quality, performing cleaning operations, and/or providing notifications according to another example embodiment. The operations illustrated in and described with respect to FIG. 22 may, for example, be performed by, with the assistance of, and/or under the control of one or more of the controller 90, 390, 490 and other components/features of the systems 10, 10′, 10″, 10′″, 300, 400 described herein.

The method 800 may include printing on the web product at operation 802. At operation 804, the method includes receiving first print quality sensor data. Then the first print quality sensor data is used, at operation 806, to determine the first print quality of one or more printheads. At operation 808, the method may comprise performing a cleaning operation and/or issuing a notification, such as described herein. Then, at operation 810, the method may include printing on the web product again. At operation 812, the method includes receiving second print quality sensor data. Then the second print quality sensor data is used, at operation 814, to determine the second print quality of the one or more printheads. At operation 816, the method may comprise performing a cleaning operation and/or issuing a notification, such as described herein. For example, if a first cleaning operation was not sufficient to properly clean the printhead, a notification may be sent indicating a need for a replacement printhead and/or a more severe cleaning operation may be performed.

FIGS. 19-22 illustrate flowcharts of various systems, methods, and computer program product according to various example embodiments described herein. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by, for example, the memory and executed by, for example, the controller 90, 390, 490. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more non-transitory computer-readable mediums on which the computer program instructions may be stored such that the one or more computer-readable memories can direct a computer or other programmable device to cause a series of operations to be performed on the computer or other programmable apparatus to produce a computer-implemented process such that the instructions which execute on the computer or other programmable apparatus implement the functions specified in the flowchart block(s).

### Conclusion

Many modifications and other embodiments of the inventions set forth herein may come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1. A system for cleaning one or more printheads used for printing on a roll of web product, the system comprising:
a printhead configured to print ink on the roll of web product to form a roll of printed web product;
a cleaning device comprising a wipe;
at least one controller configured to:
receive an indication to perform a cleaning operation of the printhead;
cause application of a cleaning additive to a portion of the wipe, wherein the cleaning additive comprises at least one of a fluid or a non-wetted cleaning product; and
cause the cleaning device to translate across the printhead to cause the wipe to be wiped across the printhead to clean the printhead, wherein the cleaning additive has been applied to the portion of the wipe prior to being wiped across the printhead.

2. The system of claim 1 further comprising a translation device attached to the cleaning device, wherein the at least one controller is configured to operate the translation device to cause the cleaning device to translate across the printhead.

3. The system of claim 1 further comprising a fluid application device, wherein the cleaning additive is the fluid, wherein the fluid application device is configured to apply the fluid to the wipe, and wherein the at least one controller is configured to operate the fluid application device to cause the fluid to be applied to the portion of the wipe.

4. The system of claim 3, wherein the fluid application device comprises a spray nozzle configured to spray the fluid onto the portion of the wipe.

5. The system of claim 3, wherein the fluid application device comprises a metered-roller configured to gather the fluid and apply the fluid onto the portion of the wipe.

6. The system of claim 1, wherein the cleaning device comprises a cassette that holds a web of the wipe, wherein the cleaning device comprises:
a first roll holder for holding an unused portion of the web of the wipe;
a second roll holder for holding a used portion of the web of the wipe;
a web path extending between the first roll holder and the second roll holder; and
a printhead contact region along the web path, wherein the printhead contact region is configured to contact the printhead as the portion of the wipe is wiped across the printhead, and
wherein the system comprises a motor for causing rotation of at least one of the first roll holder or the second roll holder to cause the portion of the wipe to move along the web path and wind up on the second roll holder.

7. The system of claim 6, wherein the cleaning additive is the fluid, and wherein the fluid is configured to be applied to the portion of the wipe prior to the portion of the wipe reaching the printhead contact region along the web path.

8. The system of claim 1, wherein the at least one controller is configured to cause the printhead to spit ink onto the portion of the wipe as the portion of the wipe with the cleaning additive already applied thereto is wiped across the printhead.

9. The system of claim 1, wherein the cleaning additive is the fluid, and wherein the cleaning device includes a sensor configured to determine a moisture level within the cleaning device.

10. The system of claim 1 further comprising a plurality of printheads arranged in a row extending in a direction corresponding to a width of the web product being printed on, wherein the at least one controller is configured to cause the cleaning device to translate across the plurality of printheads arranged in the row to cause the wipe to be wiped across each of the plurality of printheads arranged in the row to clean each of the plurality of printheads.

11. The system of claim 1, wherein the at least one controller is further configured to cause the cleaning device to translate across the printhead a second time such that a second portion of the wipe is wiped across the printhead to clean the printhead, wherein the second portion of the wipe has no cleaning additive applied thereto or a different cleaning additive applied thereto.

12. The system of claim 1, wherein the at least one controller is further configured to cause the cleaning device to receive a cleaning assistance feature while the portion of the wipe is being wiped across the printhead, wherein the cleaning assistance feature includes application of at least one of vibration, heat, cold, or sound to the portion of the wipe or printhead.

13. The system of claim 1, wherein the cleaning additive is the fluid, and wherein the fluid comprises water.

14. A method for cleaning one or more printheads used for printing on a roll of web product, the method comprising:
causing ink, via a printhead, to be applied to the roll of web product to form a roll of printed web product;
receive an indication to perform a cleaning operation of the printhead;
cause application of a cleaning additive to a portion of a wipe of a cleaning device, wherein the cleaning additive comprises at least one of a fluid or a non-wetted cleaning product; and
cause the cleaning device to translate across the printhead to cause the portion of the wipe of the cleaning device to be wiped across the printhead to clean the printhead, wherein the cleaning additive has been applied to the portion of the wipe prior to the wipe being wiped across the printhead.

15. The method of claim 14, wherein the cleaning additive is the fluid, and wherein the method comprises causing application of the cleaning additive by causing a fluid application device to apply the fluid to the portion of the wipe.

16. The method of claim 14 further comprising causing the cleaning device to translate across the printhead a second time such that a second portion of the wipe is wiped across the printhead to clean the printhead, wherein the second portion of the wipe has no cleaning additive applied thereto or a different cleaning additive applied thereto.

17. The method of claim 14 further comprising causing the cleaning device to receive a cleaning assistance feature while the portion of the wipe is being wiped across the printhead, wherein the cleaning assistance feature includes application of at least one of vibration, heat, cold, or sound to the portion of the wipe or printhead.

18. A system for cleaning one or more printheads used for printing on a roll of web product, the system comprising:
a printhead configured to print ink on the roll of web product to form a roll of printed web product;
a cleaning device comprising a wipe with a pre-applied cleaning additive, wherein the cleaning additive is one of a fluid or a non-wetted cleaning product;
at least one controller configured to:
cause the cleaning device to translate across the printhead to cause the wipe to be wiped across the printhead to clean the printhead.

19. The system of claim 18, wherein the cleaning device comprises a housing configured to enclose the wipe when the wipe is not being used to clean the printhead.

20. A method for monitoring print quality of printheads used for printing on a roll of web product, the method comprising:
causing ink, via a printhead, to be applied to the roll of web product;
receiving sensor data from a sensor configured to sense a print quality of the ink applied to the roll of web product by the printhead;
determining, based on the sensor data, a print quality of the printhead based on the print quality of the ink applied to the roll of web product; and
causing, in an instance in which the determined print quality of the printhead is below a threshold print quality level, a cleaning operation to be performed, wherein the cleaning operation comprises:
causing application of a cleaning additive to a portion of a wipe of a cleaning device, wherein the cleaning additive comprises at least one of a fluid or a non-wetted cleaning product; and
causing the cleaning device to translate across the printhead to cause the portion of the wipe of the cleaning device to be wiped across the printhead to clean the printhead, wherein the cleaning additive has been applied to the portion of the wipe prior to the wipe being wiped across the printhead.

21. The method of claim 20 further comprising:
causing, via the printhead, additional ink to be applied to the roll of web product;
receiving second sensor data from the sensor, wherein the second sensor data is based on a print quality of the additional ink applied to the roll of web product by the printhead;
determining, based on the second sensor data, a second print quality of the printhead based on the print quality of the additional ink applied to the roll of web product; and
causing, in an instance in which the determined second print quality of the printhead is below at least one of the threshold print quality level or a different threshold print quality level, a notification to be provided to a user, wherein the notification indicates a need to replace or service the printhead.
